(19) United States
(12) Patent Application Publication
(10) Pub. No.: US 2006/0001311 A1
(43) Pub. Date: Jan. 5, 2006

(54) Front steer axle air suspension system

(76) Inventors: David K. Platner, Shelby, MI (US); Benjamin R. Reineck, Waterford, MI (US); James Trotter, Auburn Hills, MI (US); Tjong T. Lie, Naperville, IL (US); Jonathan S. Rose, Orion, MI (US); Richard M. Clisch, Canton, MI (US); James R. Brichta, Highland, MI (US); Rajesh J. Somnay, Troy, MI (US); Gregory D. Pavuk, Royal Oak, MI (US); Xinyu Wen, Auburn Hills, MI (US); Edward Jay Eshelman, Rochester Hills, MI (US); Ragnar H. Ledesma, Sterling Heights, MI (US); Kenneth Hooper, Livonia, MI (US); Leonard Jenaway, Macomb, MI (US); Michael Nelson, Royal Oak, MI (US); Kou Yang, Goodrich, MI (US); Felipe Susin, Troy, MI (US); Robert Baroni, White Lake, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/883,565

(22) Filed: Jul. 1, 2004

(51) Int. Cl. B60B 35/00

(52) U.S. Cl. 301/124.1

(57) ABSTRACT

An air suspension system for a non-drive steering axle includes a set of air springs supported on an axle beam extending between a pair of rotating wheels. The axle beam defines a lateral axis about which the wheels rotate. A lateral stiffener assembly cooperates with the axle beam, which provides torsional stiffness, to provide high lateral stiffness in the air suspension system. The lateral stiffener assembly includes a first arm that extends from the axle beam transverse to the lateral axis and is positioned on one lateral side of the vehicle. A second arm extends from the axle beam transverse to the lateral axis and is positioned on an opposite lateral side of the vehicle. Each of the first and second arms has one arm end supported by the axle beam and an opposite arm end mounted to a vehicle frame member.

### BACKGROUND OF THE INVENTION

Heavy vehicles, such as tractor-trailers, have a tractor vehicle that includes front axle and a rear axle. The front axle is typically a front non-drive steer axle and the rear axle is typically a rear tandem drive axle. Air suspension systems are commonly used on the rear tandem drive axle. However, the front non-drive steer axle has traditionally used a mechanical or spring suspension. This is because front air suspensions have had limited success due to a sluggish feel generated by the air suspension on the front axle.

The front non-drive steer axle has an axle beam that extends between a pair of steering knuckles. The steering knuckles each include a spindle portion for supporting a wheel. A knuckle pin, also referred to as a kingpin, is used to attach each end of the axle beam to a respective steering knuckle. The kingpin defines a steering axis. A steering arm provides steering input to one of the steering knuckles. A tie rod assembly interconnects the steering knuckles to transfer steering input from one steering knuckle to the other steering knuckle. The kingpin provides articulation between the steering knuckles and axle beam so that a vehicle can execute turning maneuvers via the steering arm and tie rod assembly.

The front air suspension typically includes a pair of laterally spaced spring assemblies that are mounted to the axle beam at one end and mounted to a vehicle frame at an opposite end with a shackle. Air springs are positioned between the axle beam and the vehicle frame.

Another undesirable operational response for a front suspension on a front non-drive steer axle is referred to as a shimmy mode. The shimmy mode can exist with front suspensions having low lateral stiffness or insufficient damping. The shimmy mode is defined as front wheel rotation about the kingpin in phase, with a slight tramp mode. Tramp is related to wheel hop, which is a vertical oscillatory motion of a wheel between a road surface and a sprung mass. The tramp mode is a form of wheel hop in which a pair of wheels hop in opposite phase.

Many different solutions have been proposed to address the shimmy problem. One solution has been to change the caster angle. The caster angle is an angle, in side elevation, between the steering axis and the vertical. Another solution increased shackle bushing stiffness and/or shackle link thickness. Other solutions have included changing ride height, fixing the axle beam to the leaf spring assemblies, or providing kingpin damping. Each of these solutions has had limited success but has not eliminated the shimmy mode problem.

There is a need for an air suspension system that can be used on a front non-drive steer axle that improves ride and performance, as well as overcoming the other mentioned deficiencies in the prior art.

### SUMMARY OF THE INVENTION

An air suspension system includes a lateral stiffener assembly that improves air suspension ride and performance. In one example, the air suspension system is used for a non-drive axle assembly having an axle beam defining a lateral axis extending between a pair of rotating wheels. The lateral stiffener assembly includes first and second arms that extend transverse to the lateral axis. The first arm has a first arm end supported by the axle beam at a first lateral side of a vehicle and the second arm has a first arm end supported by the axle beam at a second lateral side of the vehicle opposite the first lateral side. Each of the first and second arms has a second arm end that is mountable to a vehicle structure, such as a vehicle frame member, for example.

The air suspension system includes air springs that are supported by the axle beam. The air springs are mounted to the axle beam with a bracket. The lateral stiffener assembly is positioned on a first longitudinal side of the axle beam and the air springs are positioned on a second longitudinal side opposite from the first longitudinal side. The air springs are connectable to the vehicle frame member.

The vehicle frame member includes a pair of c-channels or support beams that extend in a longitudinal direction, which is transverse to the lateral axis. One support beam is positioned at the first lateral side and another support beam is positioned at the second lateral side. The air springs and the lateral stiffener assembly are connectable to the support beams.

In one disclosed embodiment, the second arm end for the first arm is mounted to the support beam at the second lateral side and the second arm end for the second arm is mounted to the support beam at the first lateral side. In this configuration, the first and second arms are non-parallel to each other and are positioned to form a X-shape relative to the pair of support beams.

In another disclosed embodiment, the second arm end for the first arm is mounted to the support beam at the first lateral side and the second arm end for the second arm is mounted to the support beam at the second lateral side. In this configuration, the first and second arms extend generally parallel to the support beams and are generally perpendicular relative to the lateral axis. A stiffener member is used to interconnect the first and second arms. The stiffener member comprises a beam or tube that is generally parallel to the lateral axis and includes a first end mounted to the first arm and a second end mounted to the second arm.

The air suspension system utilizes a lateral stiffener assembly to improve air suspension ride and performance by reducing shimmy. These and other features of the present invention can be best understood from the following specification and drawings, the following of which is a brief description.

### BRIEF DESCRIPTION OF THE DRAWINGS

FIG. 1 shows a perspective view of a front non-drive steer axle assembly.

FIG. 2 is a partial perspective view of one example of an air suspension for a front non-dive steer axle incorporating the subject invention.

FIG. 3 is a partial perspective view of another example of an air suspension incorporating the subject invention.

FIG. 4 is a partial perspective view of another example of an air suspension incorporating the subject invention.

FIG. 5 is a partial perspective view of another example of an air suspension incorporating the subject invention.

FIG. 6 is a perspective view of a lateral stiffener shown in FIG. 5.

FIG. 7 is a perspective view of another lateral stiffener.

FIG. 8 is a partial perspective view of another example of an air suspension incorporating the subject invention.

FIG. 9 is a perspective view of a bracket used in the example of FIG. 8.

FIG. 10 is a partial perspective view of another example of an air suspension incorporating the subject invention.

FIG. 11 is a perspective top view of a lateral stiffener shown in FIG. 10.

FIG. 12 is a perspective bottom view of the lateral stiffener of FIG. 11.

### DETAILED DESCRIPTION OF THE PREFERRED EMBODIMENT

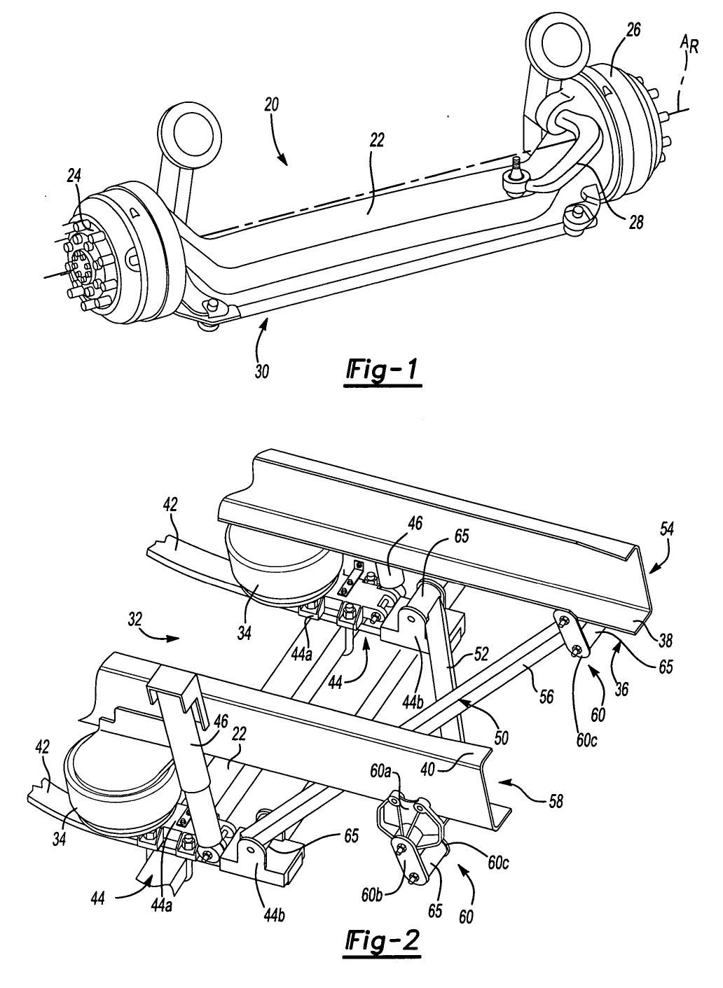

A front non-drive steer axle is shown generally at 20 in FIG. 1. The front non-drive steer axle 20 includes a generally rigid axle beam 22 extending between first and second wheel ends 24, 26. The first and second wheel ends 24, 26 are laterally spaced apart from each other and define a lateral axis of rotation A_{R}. The front non-drive steer axle 20 also includes a steering arm 28 and tie rod assembly 30 that cooperate to turn the first and second wheel ends 24, 26 during steering maneuvers, as known in the art.

An air suspension system 32, shown in FIG. 2, includes a pair of air springs 34 positioned between the axle beam 22 and a vehicle frame 36. The vehicle frame 36 includes a first c-channel 38 positioned on one lateral side of a vehicle and a second c-channel 40 positioned on an opposite side of the vehicle. The first and second c-channels 38, 40 extend in a generally longitudinal direction along a length of the vehicle. The longitudinal direction is generally perpendicular to a lateral direction defined by the lateral axis of rotation A_{R}.

Each air spring 34 is supported on an air spring support arm 42 that is positioned on one longitudinal side of the lateral axis of rotation A_{R}. A mounting bracket 44 attaches each air spring support arm 42 to the axle beam 22. The mounting bracket 44 also attaches one end of a shock absorber 46 to the axle beam 22. An opposite end of the shock absorber 46 is mounted to the vehicle frame 36.

The bracket 44 can be a single piece bracket or a multiple piece bracket. In the configuration shown in FIG. 2, the bracket 44 includes a first piece 44a and a second piece 44b. The first piece 44a is used to mount the air spring support arm 42 and shock absorber 46 to the axle beam 22. The second piece 44b attaches a lateral stiffener assembly 50 to the axle beam 22.

The lateral stiffener assembly 50 is solely incorporated into the air suspension system 32 to increase lateral stiffness. The lateral stiffener assembly 50 is not intended to add roll stiffness. In the example of FIG. 2, the lateral stiffener assembly 50 includes a first arm 52 having one end mounted to the second piece 44b of bracket 44 at a first lateral side 54 of the vehicle and a second arm 56 having one end mounted to the second piece 44b of bracket 44 at a second lateral side 58 of the vehicle. The first arm 52 has an opposite end mounted to the vehicle frame 36 at the second lateral side 58 and the second arm 56 has an opposite end mounted to the vehicle frame 36 at the first lateral side 54. In one example, the first and second arms 52, 56 are formed from a resilient spring material to allow flexing during vehicle operation. Any type of spring material known in the art could be used to form the first and second arms 52, 56.

As shown in FIG. 2, the first and second arms 52, 56 are non-parallel to each other and extend transversely to the axle beam 22 and lateral axis of rotation A_{R}. In this configuration, the first and second arms 52, 56 are orientated to form an “X” relative to the first and second c-channels 38, 40.

The c-channels 38, 40 each include a shackle 60 for mounting the opposite ends of the first and second arms 52 56 to the vehicle frame 36. The shackle 60 includes a bracket 60a and a pair of drop links 60b and 60c, as known.

In the example of FIG. 2, both ends of the first and second arms 52, 56 are supported in bushing mounts 65. The bushing mounts 65 preferably have a high lateral rate, which means that the bushings are very stiff in a side-to-side direction.

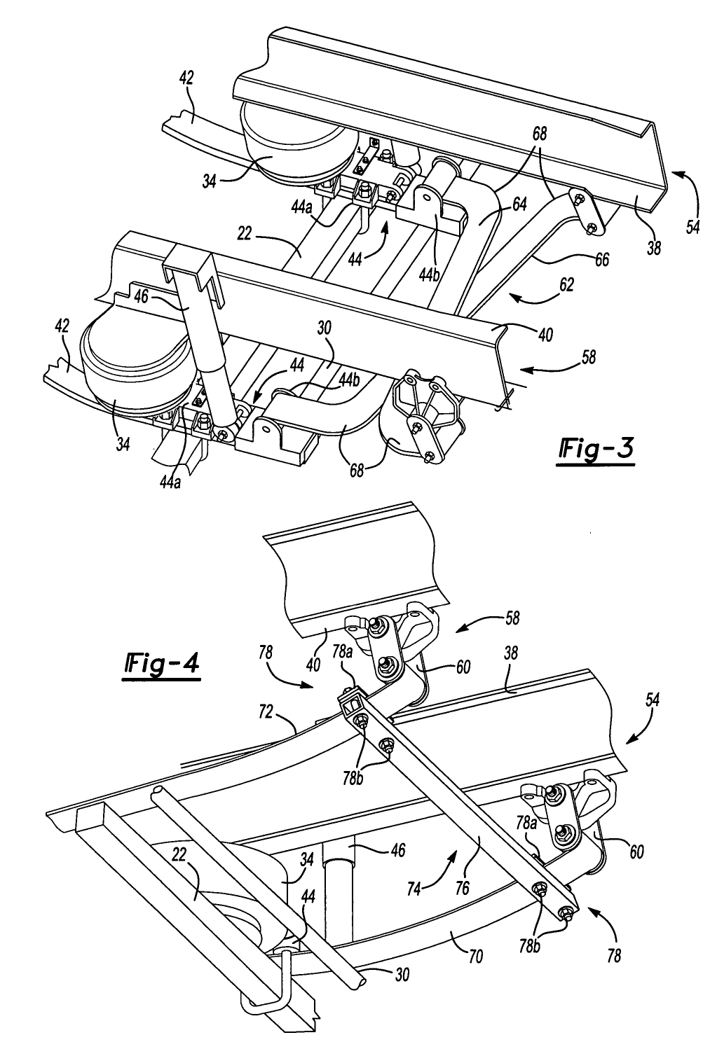

FIG. 3 shows another example of a lateral stiffener assembly 62. This lateral stiffener assembly is similar to that shown in FIG. 2 and includes first and second arms 64, 66 formed from a resilient spring material. In this example, however, the first and second arms 64, 66 each include curved end portions 68.

The example of FIG. 4 includes first and second leaf springs 70, 72 that extend in a generally longitudinal direction parallel to the first and second c-channels 38, 40. The first and second leaf springs 70, 72 are resilient, flexible members. The first and second leaf springs 70, 72 each have one end attached to the axle beam 22 with the bracket 44 and an opposite end attached to the shackle 60 in a manner similar to that described above.

A lateral stiffener assembly 74 interconnects the first and second leaf springs 70, 72. The lateral stiffener assembly 74 includes a tube 76 that is clamped to the first and second leaf springs 70, 72 with a clamp assembly 78. One clamp assembly 78 is used for each of the first and second leaf springs 70, 72.

The clamp assembly 78 includes a bracket 78a , which is positioned at one of an upper or lower surface of the first and second leaf springs 70, 72. The tube 76 is positioned opposite the bracket 78a at the other of the upper or lower surface of the first and second leaf springs 70, 72. The clamp assembly 78 also includes a plurality of fasteners 78b that are inserted through the bracket 78a and into the tube 76. The fasteners 78b do not extend through the first and second leaf springs 70, 72. Instead, one fastener 78b is positioned at each lateral side of the respective first or second leaf spring 70, 72. In this configuration, the first and second leaf springs 70, 72 are clamped between the bracket 78a and tube 76.

The tube 76 can have any type of cross-sectional shape. A square tube is shown, however, an oval, circular, rectangular, or other shape could also be used. Further, a solid bar could also be used, however, a tube configuration is preferred for weight reduction.

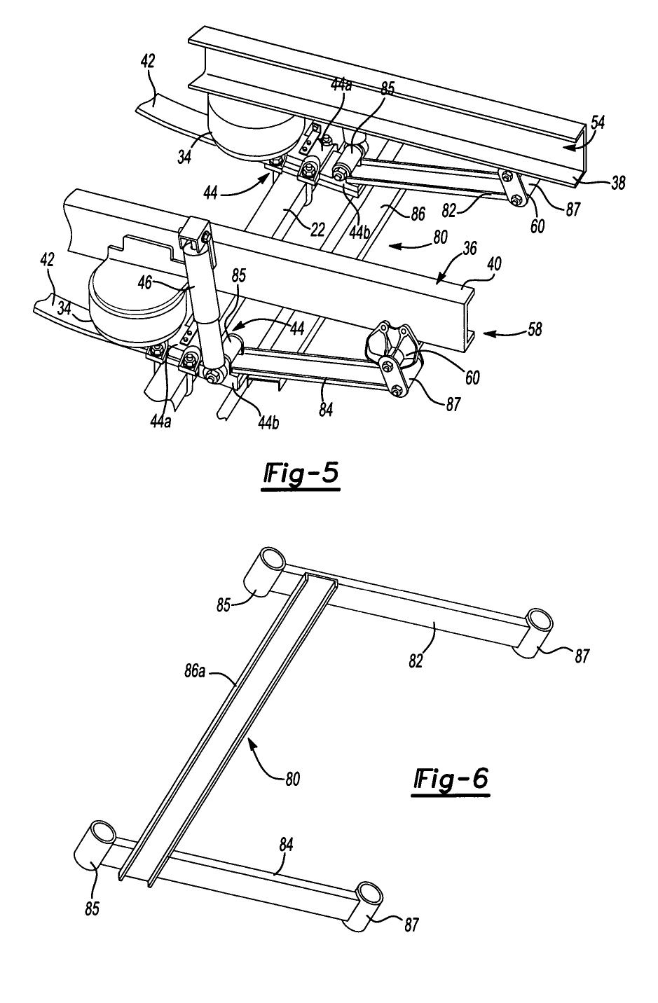

FIGS. 5, 6, and 7 show an example of another lateral stiffener assembly 80. In this example, the lateral stiffener assembly 80 includes first and second arms 82, 84 that extend in a generally longitudinal direction parallel to the c-channels 38, 40. The first and second arms 82, 84 are preferably formed in a c-channel shape, however, other shapes could also be used. The first and second arms 82, 84 are generally parallel to each other and are positioned on the first and second lateral sides 54, 58, respectively. The first and second arms 82, 84 each include a first arm end that is mounted to the axle beam 22 via bracket 44 and a second arm end that is mounted to the vehicle frame 36 via the shackle 60, as described above.

A beam member 86 extends in a generally lateral direction, parallel to the lateral axis of rotation A_{R}, and is spaced longitudinally from the axle beam 22. The beam member 86 is bolted, welded, or otherwise attached to the first and second arms 82, 84. Further, the beam member 86 can be positioned at any longitudinal position along the first and second arms 82, 84 relative to the axle beam 22. In the configuration shown in FIG. 5, the beam member 86 is positioned longitudinally closer to bracket 44 than shackle 60. Longitudinal position could vary to accommodate additional components in a limited packaging space.

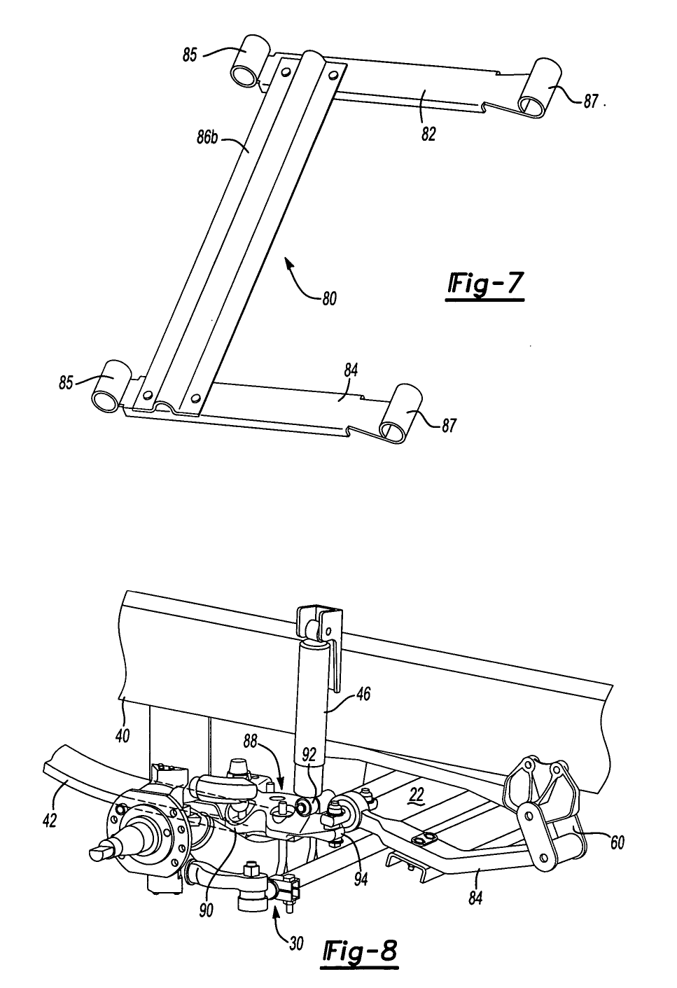

The beam member 86 is preferably a resilient member that can have a c-shape 86a as shown in FIG. 6 or can have a u-shape with transversely extending flanges 86b as shown in FIG. 7. Other cross-sectional shapes could also be used.

The first and second arms 82, 84 each include a first end mounted to the second piece 44b of bracket 44 and a second end mounted to the shackle 60. The first end is preferably mounted to the second piece 44b with a bushing mount 85. The second end is preferably mounted to the shackle 60 with a bushing mount 87. The bushing mounts 85, 87 have a high lateral rate, as described above. The bushing mounts allow movement of the first and second arms 82, 84 relative to the axle beam 22 and vehicle frame 36.

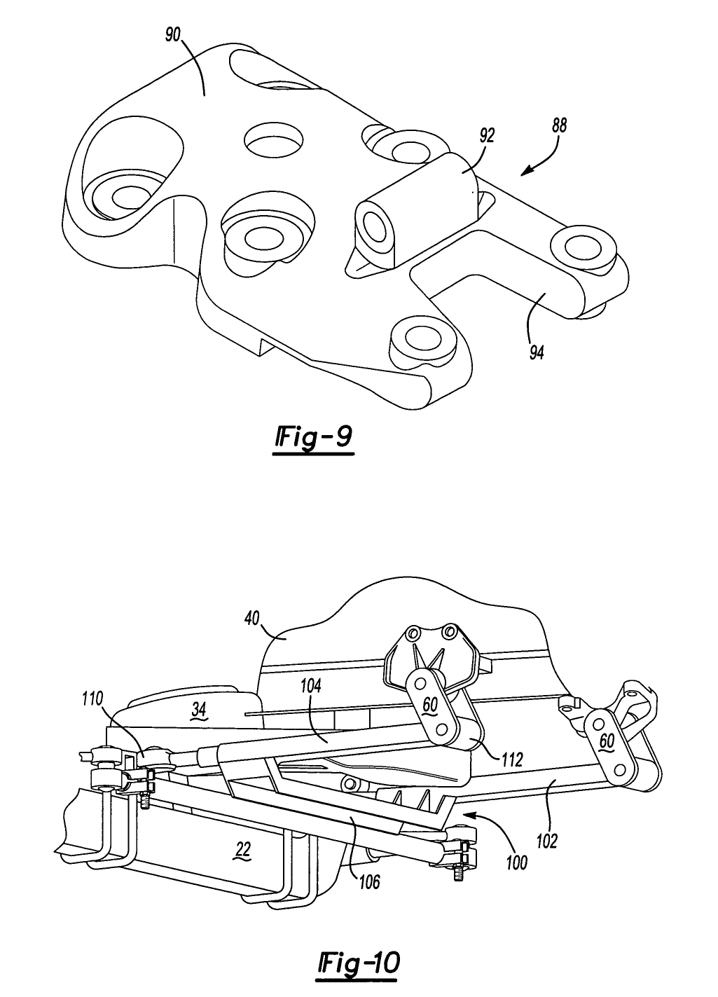

As discussed above, the bracket 44 can be formed from multiple pieces or can be integrally formed as a single piece bracket 88, as shown in FIGS. 8 and 9. One single piece bracket 88 is positioned at each of the first and second lateral sides 54, 58 of the vehicle. The single piece bracket 88 includes a first portion 90 for mounting the air spring support arm 42 and the bracket 88 to the axle beam 22, a second portion 92 for mounting the shock absorber 46 to the axle beam 22, and a third portion 94 for attaching the first and second arms 82, 84 to the axle beam 22.

FIGS. 10, 11, and 12 show another example of a lateral stiffener assembly 100. In this example, the lateral stiffener assembly 100 includes first and second arms 102, 104 that extend in a generally longitudinal direction parallel to the c-channels 38, 40. The first and second arms 102, 104 are generally parallel to each other and are positioned on the first and second lateral sides 54, 58, respectively. A beam member 106 extends in a generally lateral direction, parallel to the lateral axis of rotation A_{R}, and is spaced longitudinally from the axle beam 22. The beam member 106 is bolted, welded, or otherwise attached to the first and second arms 102, 104.

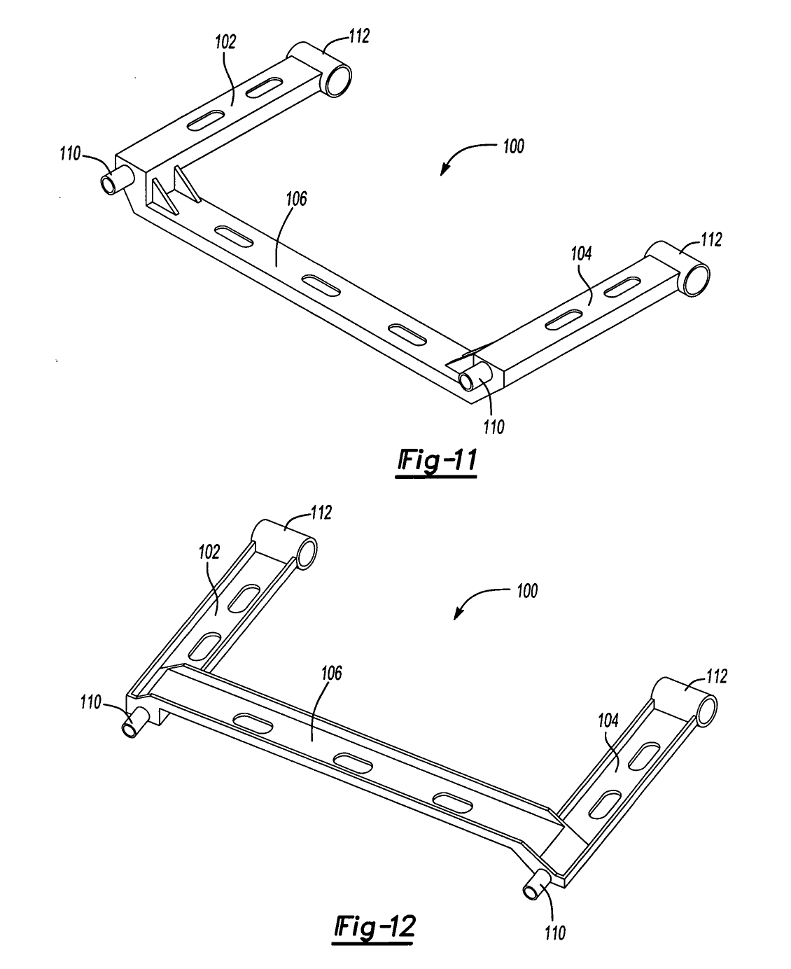

The beam member 106 is preferably a resilient member that can have a c-shape as shown in FIGS. 11 and 12. Other cross-sectional shapes could also be used. Further, the beam member 106 and the first and second arms 102, 104 can be formed from separate pieces or integrally formed as a single piece member as shown in FIGS. 11 and 12.

The first and second arms 102, 104 each include a first end mounted to the bracket 44 and a second end mounted to the shackle 60. In this example, the first end is a ball stud attachment 110 that allows movement of the first and second arms 102, 104 relative to the axle beam 22 and the second end is a bushing attachment 112 that allows movement of the first and second arms relative to the vehicle frame 36.

Lateral stiffness is very important to successful responsiveness for a front non-drive steer axle 20 having an air suspension system 32. Use of a lateral stiffener assembly in combination with a torsionally stiff axle beam 22, as described above, can provide high lateral stiffness in the air suspension system 32. The lateral stiffener assembly improves and maintains a desired level of lateral stiffness without influencing roll or vertical suspension characteristics.

The lateral stiffener assembly is connected to the axle beam 22 with a joint connection such as a bushing, bearing, ball joint, or other similar connection to provide high lateral and radial rates but low rotation rates. The lateral stiffener assembly is also connected to the shackle 60 with a bushing connection having similar rates as the joint connection to the axle beam 22.

An important feature to this design is the interaction with an axle member, i.e. the axle beam 22, that provides a high torsional response that is reacted through front suspension members. Front suspension member connection to the vehicle frame 36 should also have high lateral and radial stiffness rates but a low rotational rate. The air spring 34 is designed to respond to 100% of the required vertical loading requirements, which focuses front and rear attachment points to support lateral, fore-aft, and braking loads. Roll loads are reacted through the front suspension member connection.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An air suspension for an axle assembly comprising:
a first arm extending transversely to a non-rotating axle component that defines a generally lateral direction extending between a pair of wheel ends, said first arm having a first arm end supportable by the non-rotating axle component at a first lateral vehicle side; and
a second arm extending transversely to the non-rotating axle component and having a first arm end supportable by the non-rotating axle component at a second lateral vehicle side opposite the first lateral vehicle side, said first and second arms each including a second arm end mountable to a vehicle frame at one of the first or second lateral vehicle sides to increase lateral stiffness.

2. The air suspension according to claim 1 wherein said first and second arms are first and second resilient arms, respectively, wherein said second arm end of said first resilient arm is mountable to the vehicle frame at the second lateral vehicle side and said second arm end of said second resilient arm is mountable to the vehicle frame at the first lateral vehicle side.

3. The air suspension according to claim 2 wherein said first and second resilient arms are non-parallel.

4. The air suspension according to claim 1 including a stiffener member extending in the generally lateral direction and being longitudinally spaced apart from the non-rotating axle component, said stiffener member having a first end mounted to said first arm and a second end mounted to said second arm wherein said second arm end of said first arm is mountable to the vehicle frame at the first lateral vehicle side and said second arm end of said second arm is mountable to the vehicle frame at the second lateral vehicle side.

5. The air suspension according to claim 4 wherein said first and second arms are generally parallel to each other and extend in a generally longitudinal direction.

6. The air suspension according to claim 5 wherein said stiffener member and the non-rotating axle component are generally parallel to each other.

7. The air suspension according to claim 6 wherein said first arm ends of said first and second arms are supported by a bracket mounted to the non-rotating axle component.

8. The air suspension according to claim 7 wherein said first and second arms are first and second leaf springs, respectively.

9. The air suspension according to claim 8 wherein said stiffener member comprises a tube with said first end being clamped to said first leaf spring and said second end being clamped to said second leaf spring.

10. The air suspension according to claim 7 wherein said stiffener member comprises a beam extending between said first and second arms with said first end being attached to said first arm and said second end being attached to said second arm.

11. The air suspension according to claim 10 wherein said first arm end includes a first bushing mounting said first and second arms for movement relative to the non-rotating axle component and said second arm end includes a second bushing mounting said first and second arms for movement relative to the vehicle frame.

12. The air suspension according to claim 10 wherein said first arm end includes a ball stud connection mounting said first and second arms for movement relative to the non-rotating axle component and said second arm end includes a bushing connection mounting said first and second arms for movement relative to the vehicle frame.

13. The air suspension according to claim 1 including at least one air spring connectable to the vehicle frame wherein the non-rotating axle component comprises a front non-drive steer axle having an axle beam for supporting said air spring.

14. The air suspension according to claim 13 including a first bracket for mounting said first arm end of said first arm to said axle beam and a second bracket for mounting said first arm end of said second arm to said axle beam wherein said first and second brackets each include a first mounting portion for attachment to said axle beam, a second mounting portion for receiving said first arm end, and a third mounting portion for receiving a shock absorber.

15. The air suspension according to claim 13 wherein said first and second arms are positioned on one longitudinal side of said axle beam and said at least one air spring is positioned on an opposite longitudinal side of said axle beam.

16. An air suspension for an axle assembly comprising:
an axle beam defining a lateral axis extending between a pair of rotating wheel ends;
at least one air spring mounted to said axle beam adjacent one longitudinal side of said axle beam;
a first arm extending transversely to said lateral axis, said first arm having a first arm end mounted to said axle beam at a first lateral vehicle side; and
a second arm extending transversely to said lateral axis, said second arm having a first arm end mounted to said axle beam at a second lateral vehicle side opposite the first lateral vehicle side, said first and second arms being positioned on an opposite longitudinal side of said axle beam from said air spring and wherein said first and second arms each include a second arm end mountable to a vehicle frame at one of the first or second lateral vehicle sides to increase lateral stiffness.

17. The air suspension according to claim 16 wherein said second arm end of said first arm is mountable to the vehicle frame at the second lateral vehicle side and said second arm end of said second arm is mountable to the vehicle frame at the first lateral vehicle side such that said first and second arms form a X-shape.

18. The air suspension according to claim 16 including a stiffener member extending generally parallel to said lateral axis and being longitudinally spaced apart from said axle beam, said stiffener member having a first end mounted to said first arm and a second end mounted to said second arm.

19. The air suspension according to claim 18 wherein said first and second arms are generally parallel to each other and extend in a generally longitudinal direction with said second arm end of said first arm being mountable to the vehicle frame at the first lateral vehicle side and said second arm end of said second arm being mountable to the vehicle frame at the second lateral vehicle side.

20. The air suspension according to claim 19 wherein said first arm ends of said first and second arms are supported within a bushing mount formed in a bracket mounted to said axle beam.
